(19) United States
(12) Patent Application Publication
(10) Pub. No.: US 2023/0055163 A1
(43) Pub. Date: Feb. 23, 2023

(54) VERIFYING MATCHES BETWEEN IDENTIFIERS STORED IN A DIGITAL CATALOG

(71) Applicant: Maplebear Inc. (dba Instacart), San Francisco, CA (US)

(72) Inventors: Gordon McCreight, Mountain View, CA (US); Alex Charlton, San Francisco, CA (US)

(21) Appl. No.: 17/407,079

(22) Filed: Aug. 19, 2021

(51) Int. Cl. G06Q 30/00; G06Q 10/08; G06F 16/2458

(52) U.S. Cl. CPC G06Q 30/018; G06Q 10/08; G06F 16/2474

(57) ABSTRACT

An online system receives an identification code for a product from a third party, which includes attributes that the third party uses to identify the product. The online system normalizes the identification code according to a set of guidelines received from the third party. The normalized identification code resembles previous identification codes received from the third party. The online system identifies a cluster of identification codes that represents the product identified by the normalized identification code by applying a set of matching rules to the normalized identification code and updates the identified cluster of identification codes to include the normalized identification code. The online system identifies a universal product identifier that represents the product of the cluster of the cluster of identification codes and stores the universal product identifier with the updated cluster of identification code.

### BACKGROUND

This disclosure relates generally to updating a digital catalog of products and, more specifically, to updating a digital catalog of products by verifying matches between the product identifier of a product and a universal product identifier maintained by the digital catalog.

Order delivery systems receive and maintain data from many different third-party sources, but different sources may recognize a particular product or type of product using different, unique identifiers. As a result, the online delivery system may store a large number of identifiers, all of which identify a single product in the online delivery system. Additionally, some third-party sources may use multiple unique identifiers to identify a single product which further adds to the number of identifiers stored within the online delivery system and the storage capacity needed to maintain the online delivery system. Accordingly, there exists a need for an online delivery system that organizes different unique identifiers of a single product received from various third-party sources into a computationally efficient data structure.

### SUMMARY

An online concierge system maintains a digital catalog of products offered by third parties. A customer may interact with a mobile application to place an order with the online concierge system for one or more products stored in the digital product catalog for pick-up or delivery. To maintain the digital product catalog, the online concierge system receives an identification code that a third party uses to identify a product offered by the third party for pick-up or delivery. The online concierge system normalizes the identification code according to a set of guidelines received from the third party because the third party may simultaneously use identification codes with varying formats, for example some identification codes may include leading zeros or check digits while others do not. The set of guidelines describe a standardized format for identification codes received from the third party. Once normalized, the identification code received from the third party resembles the format of other identification codes received from the third party.

Additionally, within the digital product catalog, multiple third parties may offer the same product but use different identification codes to identify the product or one third party may use different identification codes to identify a single product. Accordingly, the online concierge system may store hundreds of duplicate identification codes for a single product. The online concierge system maps the normalized identification code to a cluster of other identification codes representing the same product by applying a set of matching rules to the normalized identification code. The set of matching rules are applied sequentially until a matching rule of the set identifies a cluster of identification codes corresponding to the same product as the normalized product identifier. Each matching rule considers a unique combination of attributes of a normalized product identifier when identifying the matching cluster of identification codes. The online concierge system updates the cluster of identification codes identified by the set of matching rules to include the normalized identification code for the product offered by the third party.

For each product in the digital product catalog, the online concierge system stores a universal product identifier. The online concierge system identifies a universal product identifier corresponding to the product represented by the cluster of identification codes and assigns the universal product identifier to the cluster of identification codes. After identifying the universal product identifier, the online concierge system additionally stores the universal product identifier with the updated cluster of assigned identification codes and the matching rule of the set of matching rules that mapped the normalized product identifier to the universal product identifier.

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF DRAWINGS

FIG. 1 illustrates the environment of an online concierge system, according to one embodiment.

FIG. 2 is a block diagram of an online concierge system, according to one embodiment.

FIG. 3A is a block diagram of the customer mobile application (CMA), according to one embodiment.

FIG. 3B is a block diagram of the picker mobile application (PMA), according to one embodiment.

FIG. 4A-B are graphics illustrating the process for mapping product identifiers received from third parties to a universal product identifier, according to one embodiment.

FIG. 5 is a block diagram of a product cataloging engine, according to one embodiment.

FIG. 6 is a flowchart illustrating a process for assigning a universal product identifier to an identification code received from a third party, according to one embodiment.

The figures depict embodiments of the present invention for purposes of illustration only. One skilled in the art will readily recognize from the following description that alternative embodiments of the structures and methods illustrated herein may be employed without departing from the principles of the invention described herein.

### DETAILED DESCRIPTION

### Environment of an Online Concierge System

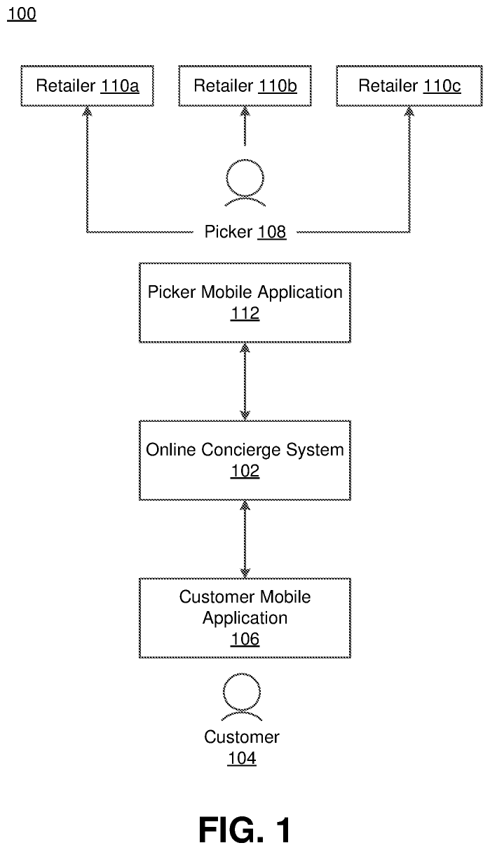

FIG. 1 illustrates the environment 100 of an online concierge system 102, according to one embodiment. The figures use reference numerals to identify like elements. A letter after a reference numeral, such as “110a,” indicates that the text refers specifically to the element having that particular reference numeral. A reference numeral in the text without a following letter, such as “110,” refers to any or all of the elements in the figures bearing that reference numeral. For example, “110” in the text refers to reference numerals “110a” and/or “110b” in the figures.

The environment 100 includes an online concierge system 102. The online concierge system 102 is configured to receive orders from one or more customers 104 (only one is shown for the sake of simplicity). An order specifies a list of goods (items or products) to be delivered to the customer 104. The order also specifies the location to which the goods are to be delivered, and a time window during which the goods should be delivered. In some embodiments, the order specifies one or more retailers from which the selected items should be purchased. The customer 104 may use a customer mobile application (CMA) 106 to place the order; the CMA 106 is configured to communicate with the online concierge system 102.

The online concierge system 102 is configured to transmit orders received from customers 104 to one or more pickers 108. A picker 108 may be a contractor, employee, or other person (or entity) who is enabled to fulfill orders received by the online concierge system 102. The environment 100 also includes three retailers 110a, 110b, and 110c (only three are shown for the sake of simplicity; the environment could include hundreds of retailers). The retailers 110 may be physical retailers, such as grocery stores, discount stores, department stores, etc., or non-public warehouses storing items that can be collected and delivered to customers 104. The retailers may also be referred to as warehouse locations. Each picker 108 fulfills an order received from the online concierge system 102 at one or more retailers 110, delivers the order to the customer 104, or performs both fulfillment and delivery. In one embodiment, pickers 108 make use of a picker mobile application 112 which is configured to interact with the online concierge system 102.

### Online Concierge System

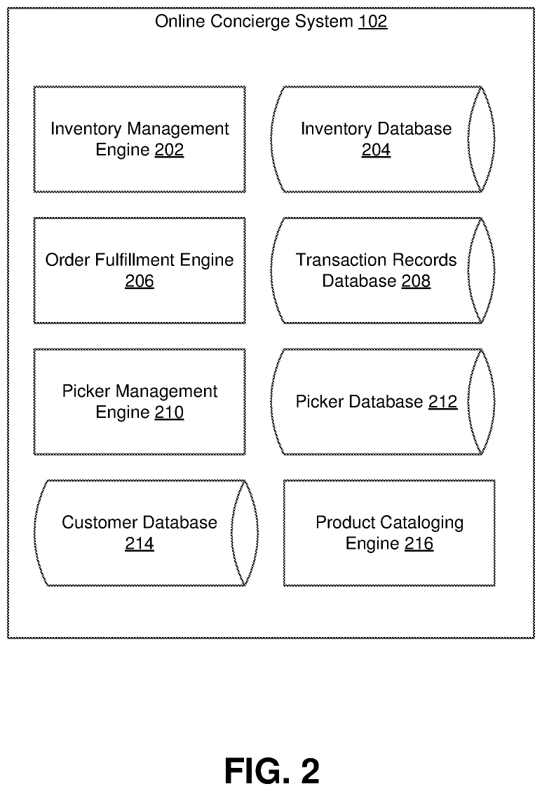

FIG. 2 is a block diagram of an online concierge system 102, according to one embodiment. The online concierge system 102 includes an inventory management engine 202, which interacts with inventory systems associated with each retailer 110. In one embodiment, the inventory management engine 202 requests and receives inventory information maintained by the retailer 110. The inventory of each retailer 110 is unique and may change over time. The inventory management engine 202 monitors changes in inventory for each participating retailer 110. The inventory management engine 202 is also configured to store inventory records in an inventory database 204. The inventory database 204 may store information in separate records—one for each participating retailer 110—or may consolidate or combine inventory information into a unified record. Inventory information includes both qualitative and qualitative information about items, including size, color, weight, SKU, serial number, and so on. In one embodiment, the inventory database 204 also stores purchasing rules associated with each item, if they exist. For example, age-restricted items such as alcohol and tobacco are flagged accordingly in the inventory database 204.

The online concierge system 102 also includes an order fulfillment engine 206 which is configured to synthesize and display an ordering interface to each customer 104 (for example, via the customer mobile application 106). The order fulfillment engine 206 is also configured to access the inventory database 204 in order to determine which products are available at which retailers 110. The order fulfillment engine 206 determines a sale price for each item ordered by a customer 104. Prices set by the order fulfillment engine 206 may or may not be identical to in-store prices determined by retailers 110 (which is the price that customers 104 and pickers 108 would pay at retailers). The order fulfillment engine 206 also facilitates transactions associated with each order. In one embodiment, the order fulfillment engine 206 charges a payment instrument associated with a customer 104 when he/she places an order. The order fulfillment engine 206 may transmit payment information to an external payment gateway or payment processor. The order fulfillment engine 206 stores payment and transactional information associated with each order in a transaction records database 208.

The order fulfillment engine 206 also determines replacement options for items in an order. For each item in an order, the order fulfillment engine 206 may retrieve data describing items in previous orders facilitated by the online concierge system 102, previously selected replacement options for that item, and similar items. Similar items may be items of the same brand or type or of a different flavor. Based on this data, the order fulfillment engine 206 creates a set of replacement options for each item in the order comprising the items from the data. The order fulfillment engine 206 ranks replacement options in the set to determine which items to display to the customer 104. In some embodiments, the order fulfillment engine 206 may rank the replacement options by the number of previous orders containing the replacement option or user quality ratings gathered by the online concierge system 102. In some embodiments, the order fulfillment engine 206 only uses data for the customer 104 related to the order to suggest replacement options.

In some embodiments, the order fulfillment engine 206 also shares order details with retailer 110. For example, after successful fulfillment of an order, the order fulfillment engine 206 may transmit a summary of the order to the appropriate retailer 110. The summary may indicate the items purchased, the total value of the items, and in some cases, an identity of the picker 108 and customer 104 associated with the transaction. In one embodiment, the order fulfillment engine 206 pushes transaction and/or order details asynchronously to retailer systems. This may be accomplished via use of webhooks, which enable programmatic or system-driven transmission of information between web applications. In another embodiment, retailer systems may be configured to periodically poll the order fulfillment engine 206, which provides detail of all orders which have been processed since the last request.

The order fulfillment engine 206 may interact with a picker management engine 210, which manages communication with and utilization of pickers 108. In one embodiment, the picker management engine 210 receives a new order from the order fulfillment engine 206. The picker management engine 210 identifies the appropriate retailer 110 to fulfill the order based on one or more parameters, such as the contents of the order, the inventory of the retailers 110, and the proximity to the delivery location. The picker management engine 210 then identifies one or more appropriate pickers 108 to fulfill the order based on one or more parameters, such as the picker's proximity to the appropriate retailer 110 (and/or to the customer 104), his/her familiarity level with that particular retailer 110, and so on. Additionally, the picker management engine 210 accesses a picker database 212 which stores information describing each picker 108, such as his/her name, gender, rating, previous shopping history, and so on. The picker management engine 210 transmits the list of items in the order to the picker 108 via the picker mobile application 112. The picker database 212 may also store data describing the sequence in which the pickers 108 picked the items in their assigned orders.

As part of fulfilling an order, the order fulfillment engine 206 and/or picker management engine 210 may access a customer database 214 which stores information describing each customer 104. This information could include each customer's name, address, gender, shopping preferences, favorite items, stored payment instruments, and so on.

The product cataloging engine 216 organizes information stored in the inventory database 204 into a catalog of products sold by the retailers associated with the online concierge system 102. In particular, the product cataloging engine 216 assigns a universal product identifier to each product in the product catalog. However, individual retailers may use different identification codes to identify the same product and, in some implementations, an individual retailer may use multiple identification codes to identify a single product. For example, three different grocery stores may identify a banana using three different identification codes. Accordingly, the product cataloging engine stores a universal product identifier for a “banana” and maps the universal product identifier to a cluster of third-party identification codes representing bananas that includes the three different identification codes used by the three different grocery stores.

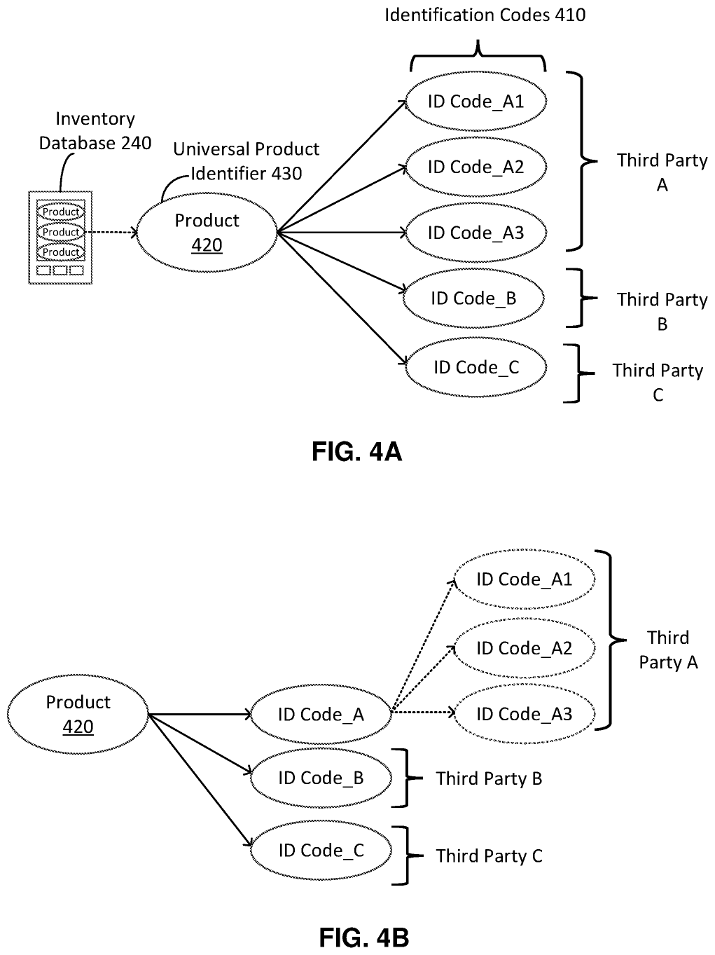

As the inventory database 204 receives new identification codes, the product cataloging engine 216 periodically applies one or more matching rules, for example heuristic rules, to the new identification codes to identify universal product identifiers corresponding to the new identification codes and adds the new identification codes to the cluster assigned to each corresponding universal product identifier. To improve the speed and computational efficiency with which the online concierge system 230 can match new identification codes to existing universal product identifiers, the online concierge system 230 may maintain a record identifying which matching rule was responsible for identifying the universal product identifier corresponding to an identification code and, more generally, which matching rules are most accurate in assigning identification codes received from a particular third party. The product cataloging engine 216 is further described below with reference to FIGS. 4-6.

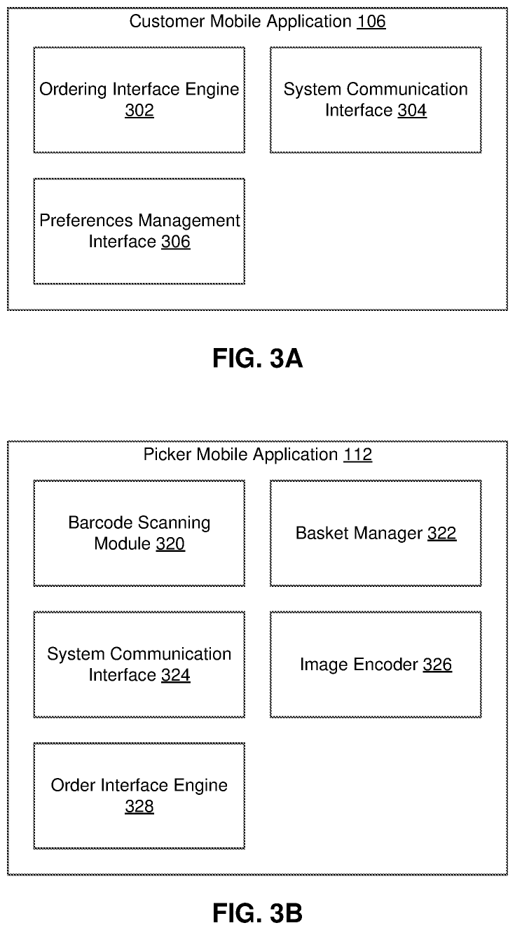

FIG. 3A is a block diagram of the customer mobile application (CMA) 106, according to one embodiment. The customer 104 accesses the CMA 106 via a client device, such as a mobile phone, tablet, laptop, or desktop computer. The CMA 106 may be accessed through an app running on the client device or through a website accessed in a browser. The CMA 106 includes an ordering interface 302, which provides an interactive interface, known as a customer ordering interface, with which the customer 104 can browse through and select products and place an order.

Customers 104 may also use the customer ordering interface to message with pickers 108 and receive notifications regarding the status of their orders. Customers 104 may view their orders and communicate with pickers 108 regarding an issue with an item in an order using the customer ordering interface. For example, a customer 104 may respond to a message from a picker 108 indicating that an item cannot be retrieved for the order by selecting a replacement option for the item or requesting a refund via buttons on the customer ordering interface. Based on the chosen course of action, the customer ordering interface generates and displays a template message for the customer 104 to send to the picker 108. The customer 104 may edit the template message to include more information about the item or course of action and communicate back and forth with the picker 108 until the issue is resolved.

The CMA 106 also includes a system communication interface 304 which, among other functions, receives inventory information from the online concierge system 102 and transmits order information to the online concierge system 102. The CMA 106 also includes a preferences management interface 306 which allows the customer 104 to manage basic information associated with his/her account, such as his/her home address and payment instruments. The preferences management interface 306 may also allow the user to manage other details such as his/her favorite or preferred retailers 110, preferred delivery times, special instructions for delivery, and so on.

FIG. 3B is a block diagram of the picker mobile application (PMA) 112, according to one embodiment. The picker 108 accesses the PMA 112 via a mobile client device, such as a mobile phone or tablet. The PMA 112 may be accessed through an app running on the mobile client device or through a website accessed in a browser. The PMA 112 includes a barcode scanning module 320 which allows a picker 108 to scan an item at a retailer 110 (such as a can of soup on the shelf at a grocery store). The barcode scanning module 320 may also include an interface which allows the picker 108 to manually enter information describing an item (such as its serial number, SKU, quantity and/or weight) if a barcode is not available to be scanned. The PMA 112 also includes a basket manager 322 which maintains a running record of items collected by the picker 108 for purchase at a retailer 110. This running record of items is commonly known as a “basket.” In one embodiment, the barcode scanning module 320 transmits information describing each item (such as its cost, quantity, weight, etc.) to the basket manager 322, which updates its basket accordingly. The PMA 112 also includes an image encoder 326 which encodes the contents of a basket into an image. For example, the image encoder 326 may encode a basket of goods (with an identification of each item) into a QR code which can then be scanned by an employee of the retailer 110 at check-out.

The PMA 112 also includes a system communication interface 324, which interacts with the online concierge system 102. For example, the system communication interface 324 receives information from the online concierge system 102 about the items of an order, such as when a customer 104 updates an order to include more or fewer items. The system communication interface 324 may receive notifications and messages from the online concierge system 102 indicating information about an order or communications from a customer 104. The system communication interface 324 may additionally generate a picker order interface to be transmitted via the PMA 112 to a picker to show orders submitted by customers 104, location information about each order, and messages from customers 104. The system communication interface 324 may receive orders and messages from customer 104 via the CMA 106 and location information from the planogram engine 216.

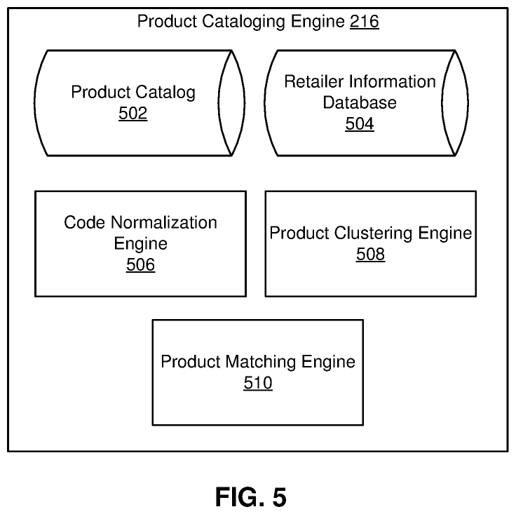

A picker order interface is an interactive interface through which pickers 108 may interact with customers 104 and receive notifications regarding the status of orders they are assigned. Pickers 108 may view their orders through the picker order interface and indicate when there is an issue with an item in an order, such as not being able to find the item, and when they have picked an item for an order (e.g., via an interactive element or scanning the item). The picker order interface displays location information about orders, such as a map of a store associated with the order, locations of items in the order (e.g., aisle, section, department, etc. of the store), a sequence for picking the items, a route through the store, a picker's location in the store, and the like. The picker order interface is further described with respect to FIGS. 5A-5C.

In some embodiments, the PMA 112 also includes a preferences management interface 306 which allows the picker 108 to manage basic information associated with his/her account, such as his/her name, preferred shopping zone, status, and other personal information. The preferences management interface 306 may also allow the picker 108 to review previous orders and/or his/her shopping level.

### Verifying Matches between Products in the Digital Product Catalog

FIG. 4A is a graphic illustration of the process for mapping identification codes received from third parties into a cluster of identification codes representing the same product, according to one embodiment. As illustrated in FIG. 4A, six different identification codes 410—ID Code_A1, ID Code_A2, ID Code_A3, ID Code_B, and ID Code_C—all represent the same product 420. The product 420 is designated within the inventory database 240 by a universal product identifier 430. However, of the six identification codes 410, ID Code_A1, ID Code_A2, and ID Code_A3 are used by a common retailer—third party A to identify the product 420, while third party B uses ID Code_B to identify the product 420 and third party C uses ID Code_C to identify the product 420.

Accordingly, the product cataloging engine 216 may preserve processing capacity of the online concierge system 130 by clustering multiple identification codes used by a single third party to identify the same product into an aggregate identification code. FIG. 4B is an illustration of the process for clustering multiple identification codes used by a single third party to represent the same product, according to one embodiment. As illustrated in FIG. 4B, the product cataloging engine 216 clusters the three identification codes received from third party A and assigns them to a single code “ID Code_A,” which represents an overall identification code used by third party A to identify the product 420.

FIG. 5 is a block diagram of the product cataloging engine 216, according to one embodiment. The product cataloging engine 216 includes a product catalog 502, a retailer information database 504, a code normalization engine 506, a product clustering engine 508, and a product matching engine 510. In some embodiments, the product cataloging engine 216 has more or different components than those shown in FIG. 5, or the components shown in FIG. 5 may be combined or removed. In other embodiments, the methods and processes described in relation to the product cataloging engine 216 may be performed at other engines or systems.

The product catalog 502 stores a record of products sold by retailers using the online concierge system 102. For each product received from a third party, the product catalog 502 additionally stores a mapping between a universal product identifier and individual identification codes received from third parties who sell the product. In some embodiments, the product catalog engine 502 is updated periodically to assign new identification codes received from third party retailers to universal identification codes of existing products or to generate universal identification codes for novel products. In other embodiments, the product catalog engine 502 is updated each time a new identification code is received from a third-party retailer.

The retailer information database 504 stores information specific to particular third-party retailers. In embodiments where a third-party retailer uses multiple identification codes to identify a single product the retailer information database stores a mapping between the multiple identification codes to an overall identification code, for example as illustrated in FIG. 4B. Additionally, in embodiments where multiple third-party retailers are related to each other, for example by common ownerships or common products, the retailer information database 504 stores a record of these relations.

As stored in the retailer information database 504, an identification code for a product is a combination of attributes describing various pieces of information for the product. Examples of such attributes include, but are not limited to, a name of the product, an image of the product, a source of the identification code (e.g., a third party retailer or an affiliated third party), a lookup code found on the product packaging, or a retailer reference code. In some embodiments, a third-party retailer provides the online concierge system 230 with identification codes of varying lengths and formats. Accordingly, the retailer information database 504 maintains and updates a set of guidelines, for example an identification code template, for each third party describing a format and/or length for identification codes received from that retailer. As will be discussed below with reference to the code normalization engine 506, the product cataloging engine 506 normalizes each identification code received from a third party according to the set of guidelines received from the third party and stores the normalized identification at the retailer information database 504.

The code normalization engine 506 normalizes an identification code according to a set of guidelines received from the third party who provided the identification code. The normalized identification code resembles other identification codes previously received from the third party or a template identification code received from the third party. In a first embodiment, the code normalization engine 506 analyzes historical identification codes received from a third party over a period of time and extracts a set of guidelines from characteristics shared among the historical identification code, for example leading zeros, check digits, a length of the code, or any other suitable characteristics of the historical identification codes. In a second embodiment, the third party defines and provides the code normalization engine 506 with the set of guidelines for the identification code, for example leading zeros, check digits, or any other suitable attributes of an identification code. In a particular embodiment, the normalized identification code is a 14-digit representation of the identification code including a check-digit.

To normalize an identification code received from a third party according to the appropriate set of guidelines, the code normalization engine 506 modifies the identification code to either resemble historical identification codes or adhere to the set of guidelines provided by the third party by adding attributes that are prescribed in the set of guidelines received from the third party but are missing from the identification code or by removing attributes that are not prescribed in the set of guidelines but are present in the identification. For example, the code normalization engine 506 adds or removes check digits from the identification code according to the set of guidelines. As another example, the code normalization engine 506 adds or removes leading zeros to adjust the length of the identification code.

In some embodiments, before searching the product catalog 502 for matching identification codes, the code normalization engine 506 extracts particular attributes from the normalized identification code, for example the third party who provided the identification code, the timestamp at which the identification code was received from the third party, the portion of the identification code identifying the product, whether the identification code includes any check digits, any other information that may be relevant to the search for a matching universal product identifier, or a combination thereof. In such embodiments, the code normalization engine 506 generates a signature for the identification code describing the third party, the product represented by the identification code, and an unfilled field for the universal product identifier corresponding to the product. Using matching rules described below, the product clustering engine 508 and the product matching engine 510 identify the corresponding universal product identifier and update the unfilled field in the signature of the normalized identification code.

The product clustering engine 506 aggregates identification codes received from different third-party retailers and identification codes received from the same third party retailer corresponding to the same product into a cluster. In some embodiments, the product clustering engine 508 sequentially applies a set of matching rules to a normalized identification code. That is, the product clustering engine 508 applies each matching rule of the set in a serial manner until a first matching rule maps the identification code to another identification code or cluster of identification codes, hereafter referred to as an ID cluster, representing the same product as the normalized identification code. As described herein, matching rules map the normalized identification to a product or an ID cluster representing the product according to an attribute of the normalized identification code. Examples of matching rules applied by the product matching engine 508, which may also be referred to herein as heuristics, are further discussed below. In some embodiments, after a first matching rule maps the identification code to an ID cluster, the product clustering engine 508 may halt the application of matching rules and assign the identification code to the ID cluster. In other embodiments, for example embodiments discussed below, the product clustering engine 508 may apply multiple matching rules to an identification code and compare the mappings generated by each matching rule.

In some embodiments, the product clustering engine 508 may begin by mapping a first identification code to a second identification code representing the same product to create an ID cluster representing the product. The product clustering engine 508 may periodically update the ID cluster representing the product by adding newly received identification codes to the existing ID cluster.

In some implementations, a first matching rule maps an identification code to a first ID cluster representing a first product while a second matching rule maps the identification code to a second ID cluster representing a second product. In such embodiments, the product clustering engine 508 may evaluate the two matching rules to determine which of the two candidate ID clusters to prioritize. To evaluate two or more matching rules, the product clustering engine 508 may determine the historical accuracy of both the first matching rule and the second matching rule. In some embodiments, the historical accuracy of a matching rule is determined based on the accuracy of the mappings between previously received identification codes and ID clusters by the matching rule. For example, a first matching rule maps an identification code to an ID cluster representing “apples,” while a second matching rule maps the identification code to an ID cluster representing “oranges.” Based on historical data of previously verified matches between ID clusters and identification codes, the first matching rule correctly maps identification codes to an ID cluster 70% of the time is more accurate, while the second matching rule correctly maps identification codes to an ID cluster 60% of the time. Accordingly, the product matching engine 508 prioritizes the more accurate, first matching rule and maps the identification code to the ID cluster identified by the first matching rule (e.g., the more accurate matching rule).

The retailer information database 504 stores a record of matching rules that most recently mapped an identification code provided by each third-party retailer to a cluster of identification codes. After mapping each identification code to an ID cluster, the product matching engine 508 updates the record of matching rules to describe the matching rule responsible for mapping the identification code and a timestamp when the identification code was received from the third party retailer. Returning to the example above regarding the first matching rule that maps an identification code to apples and the second matching rule that maps the same identification code to oranges, the product matching engine 508 updates the record of matching rules to indicate that the identification code was mapped to apples by the first matching rule.

For each third-party retailer, the record maintained by the retailer information database 504 additionally identifies the matching rule that most recently mapped an identification code provided by the retailer to a cluster of identification codes. Accordingly, when a new identification code is received from the third-party retailer, the product clustering engine 508 may apply the mostly recorded matching rule to the new identification code to improve processing time of the product cataloging engine 508. Continuing from example above where an identification code was mapped to an ID cluster by a first matching rule (e.g., the matching rule that maps an identification code to apples), the second identification code received from the same third party retailer may reference the retailer information database 504 to identify the most recently applied matching rule (e.g., the first matching rule) and apply the first matching rule to the second identification code.

If the most recently recorded matching rule (e.g., the first matching rule) does not identify a cluster of identification codes, the product clustering engine 508 may sequentially apply the remaining set of matching rules to the second identification code until a second matching rule identifies an ID cluster to which the second identification code should be assigned. The retailer information database 504 updates the record of matching rules to identify the second matching rule as the most recent matching rule and the timestamp when the second identification code was received from the third party. Accordingly, the retailer information database 504 periodically updates the record of most recent matching rules.

In some implementations, the sequence in which the product clustering engine applies matching rules may be determined based on a variety of factors. For example, the product clustering engine may rank the set of matching rules based on their accuracy and apply multiple matching rules in order from most accurate to least accurate. As another example, the record stored in the retailer information database 504 describes historical matching rules applied at various past time stamps. The product clustering engine may apply the set of matching rules sequentially in order of the most recently applied matching rules. In other embodiments, the set of matching rules may be applied sequentially in any other suitable manner or depending on any other pertinent factors.

Examples of matching rules applied by the product clustering engine 508 are discussed below. A person having ordinary skill in the art would appreciate that the examples discussed below are merely illustrative and that the set of matching rules may further include any other suitable heuristic.

As a first example, a matching rule matches an identification code to an ID cluster by comparing the retailer associated with the identification code received to the retailer associated with an ID cluster. Such retailer-specific clusters may also be referred to as retailer clusters. As a second example, a matching rule matches an identification code to an ID cluster based on a connection between the ID cluster and the source from which the identification code was received. As a third example, a matching rule matches an identification code to an ID cluster based on a connection between the source from which the identification code was received and an ID cluster which has already been assigned a universal product identifier. As a fourth example, a matching rule matches an identification code to an ID cluster based on the source from which the identification code was received and the presence of a check digit or check digit variant. In such implementations, the ID cluster is labeled with an identifier of the product (e.g., a universal product identifier), an indicator of the source, and a check digit. As a fifth example, a matching rule matches an identification code to an ID cluster based on a connection between the source of the identification code and a general category of products associated with the ID cluster. Alternatively, the matching rule matches an identification to an ID cluster based on a connection between the source of the identification code and the retailer responsible for the identification code, for example a retailer-endorsed identification code. A matching rule may additionally consider whether the source of the identification code is a content provider exclusive to a particular third-party retailer or whether the source provides identification codes for multiple third party retailers. As a sixth example, a matching rule matches an identification code to an ID cluster where all identification codes in the ID cluster are an exact match a particular universal product ID, for example identification codes historically or previously mapped to and verified as corresponding to a particular universal product ID. As a seventh example, a matching rule matches an identification code to an ID cluster based on the universal product identifier(s) historically or previously assigned to the identification code. As an eight example, a matching rule matches an identification code to an ID cluster based on the universal

[symbol]

The product matching engine 510 assigns a universal product identifier to each ID cluster representing the product associated with identification codes in the ID cluster. Whereas each identification code in the ID cluster represents a third-party retailer's designation for the product, the universal product identifier represents the designation for the product used by the product catalog 502 and, more generally, the online concierge system 102. The product catalog 502 stores the relationship between the universal product identifier and the most updated ID cluster. Simultaneously, as described above, the retailer information database 504 stores a record of each matching rule that mapped an identification code to the ID cluster assigned to the universal product identifier with a label identifying the third party retailer associated with the identification code, the timestamp when the identification code was received from the third party retailer, and the assigned universal product identifier.

In some embodiments, a third-party retailer is related to a group of third party retailers, for example a chain of related convenience stores. Such groups of third-party retailers may also be referred to as a “banner group.” Although related, each third party retailer may use a different identification code to designate the same product. Identification codes received from a third party retailer belonging to a group of related third party retailers may be designated by a common attribute embedded in the identification code. In such embodiments, the product clustering engine 508 may compare an identification code received from one third party retailer to identification codes received from other third party retailers of the group to identify a subset of identification codes received from the group of third party retailers that correspond to a single product. The product clustering engine 508 replaces the subset of identification codes with a single shared identification code that represents the product across all third party retailers in the related group.

For example, stores A, B, and C may be commonly owned by Entity D. When the product cataloging engine 216 receives an identification code from the store A for the product “apple,” the product clustering engine 216 confirms that store A is related to stores B and C and identifies the identification codes representing “apple” from stores B and C. The product cataloging engine 216 replaces each identification code for “apple” across stores A, B, and C with a single shared identification code that represents the product “apple” in stores A, B, and C.

In some embodiments, the set of matching rules applied by the product clustering engine 508 does not identify an ID cluster corresponding to the same product as a identification code received from a third party retailer, which indicates that the identification code represents a novel product not previously maintained in the product catalog, a novel product sold exclusively by the third party retailer, or both. Accordingly, the product matching engine 510 cannot match the identification code for the novel product to an existing universal product identifier. Instead, the product matching engine 510 generates a scoped product identifier that identifies the novel product. In some embodiments, the scoped product identifier may include an attribute indicating that the product is specific to the third party retailer. In some instances, other third party retailers may also begin to offer a novel product, resulting in the product matching engine 510 converting the scoped product identifier into a new universal product identifier by removing the retailer-specific attribute and generating an ID cluster assigned to the new universal product identifier. In embodiments involving an identification code received from a third party retailer related to a banner group, the product clustering engine 508 may apply a matching rule that compares the identification code to multiple scoped product identifiers assigned to the retailer banner group. Where the matching rule identifies multiple matching scoped product identifiers, the product clustering engine 508 may assign the identification code to the scoped product identifier with the most assigned identification codes. In some embodiments, in lieu of generating a scoped product identifier, a matching rule may identify a closely related ID cluster or another closely related identification code received from the same third party.

When applying the matching rules, two types of erroneous matches may arise: 1) a mismatch where two identification codes are assigned to the same ID cluster, but actually represent two distinct products or 2) a duplicate where two identifications are associated to different ID clusters, but actually represent the same product. To address mismatches, the product clustering engine 508 may split two identification codes to assign them to different ID clusters. To address duplicates, the product clustering engine 508 may merge two identification codes to assign them to the same ID cluster. Accordingly, to correct erroneous matches between ID clusters and identification codes, the product clustering engine 508 continuously re-generates ID clusters when the product cataloging engine receives a new identification code from a third-party retailer. By re-applying the most recent matching rule in view of a continuously updated data set of identification codes, the product clustering engine 508 generates ID clusters based on the product cataloging engine 216's most recent understanding of the attributes encoded in a third party retailer's identification code.

The merging of two identification codes or the splitting of two identification codes may be performed manually by a supervisor of the product catalog 502. Identification codes assigned to ID clusters by such manual revisions may be prioritized over other matches suggested by the set of mapping rules. In other iterations, the product clustering engine 508 may continue to prioritize matches defined by such manual revisions compared to other matches suggested by the matching rules. Additionally, a matching rule may match other identification codes received from a retailer with a manually matched identification code and ID cluster from the same retailer or banner group.

During each re-clustering process, the product clustering engine 508 and the product matching engine 510 may consider the universal product identifier previously assigned to an identification code. In one embodiment, after the product clustering engine 508 generates an ID cluster, the product matching engine 510 considers whether one or more identification codes in the ID cluster were previously assigned a universal product identifier. If one or more were, the product matching engine 510 identifies the universal product identifier assigned to the oldest identification code in the cluster and assigns all remaining identification codes in the cluster to the same universal product identifier. If no identification codes in the cluster were previously assigned a universal product identifier (e.g., the ID cluster represents a novel product to the product catalog), the universal product identifier generates a scoped product identifier as discussed above.

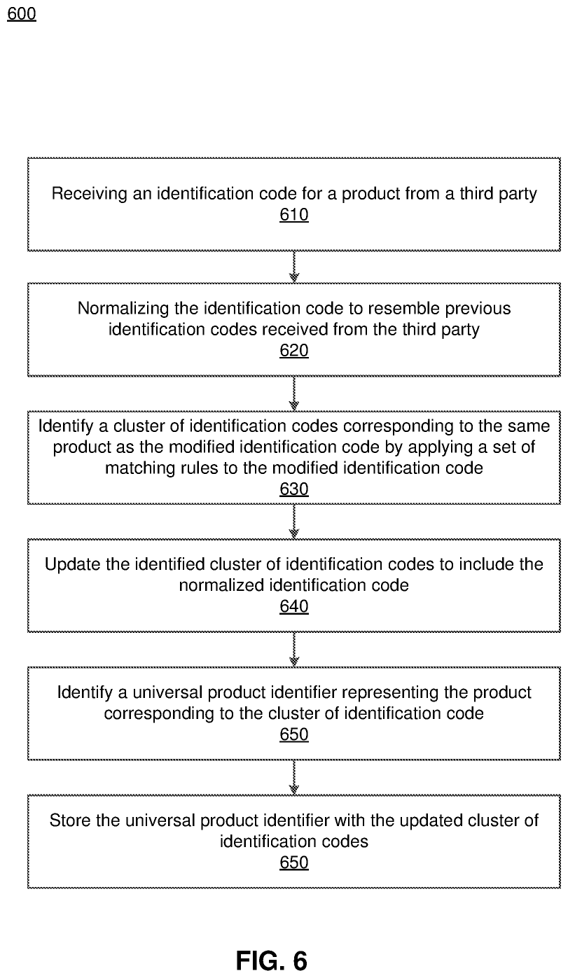

FIG. 6 is a flowchart illustrating a process for assigning a universal product identifier to an identification code received from a third party, according to one embodiment. The product cataloging engine 216 receives 610 an identification code for a product from a third party and normalizes 620 the identification code to resemble previous identification codes received from the third party. To normalize the identification code, the product cataloging engine 216 may modify the identification code by adding or removing leading zeros and/or check digits.

The product cataloging engine 216 identifies 630 a cluster of identification codes corresponding to the same product as the normalized identification code by applying a set of matching rules to the normalized identification code. The set of matching rules compare attributes in the normalized identification code to shared attributes of identification codes in the cluster or, alternatively, to an aggregate identification code for the cluster. After identifying a cluster of identification codes that matches the identification code, the product cataloging engine 216 updates 640 the identified cluster to include the normalized identification code. The product cataloging engine 216 identifies 650 a universal product identifier representing the product corresponding to the cluster of identification codes and assigns the universal product identifier to the cluster of identification codes and stores 660 the universal product identifier with the updated cluster of identification codes. Accordingly, the product cataloging engine 216 generates a digital catalog of products sold by various third-party retailers, where similar products sold by different retailers are clustered under a single universal product identifier.

### Other Considerations

The present invention has been described in particular detail with respect to one possible embodiment. Those of skill in the art will appreciate that the invention may be practiced in other embodiments. First, the particular naming of the components and variables, capitalization of terms, the attributes, data structures, or any other programming or structural aspect is not mandatory or significant, and the mechanisms that implement the invention or its features may have different names, formats, or protocols. Also, the particular division of functionality between the various system components described herein is merely for purposes of example, and is not mandatory; functions performed by a single system component may instead be performed by multiple components, and functions performed by multiple components may instead be performed by a single component.

Some portions of the above description present the features of the present invention in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of computer-readable storage medium suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for invention of enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method comprising:
receiving, at a remote server, an identification code for a product from a third party, wherein the identification code comprises attributes that the third party uses to identify the product;
normalizing the identification code according to a set of guidelines received from the third party, wherein the normalization causes the identification code to resemble previous identification codes received from the third party;
identifying, from a plurality of identification codes, a cluster of identification codes that represents the product identified by the normalized identification code by applying a set of matching rules to the normalized identification code, wherein each matching rule of the set of matching rules is applied sequentially until a first matching rule of the set of matching rules maps the normalized identification code to the cluster of identification codes based on an attribute of the normalized identification code;
updating the cluster of identification codes assigned to the identified universal product identifier to include the normalized identification code;
identifying, from a plurality of universal product identifiers, a universal product identifier that represents the product of the cluster of identification codes, wherein each universal product identifier of the plurality of universal product identifiers represents a product provided by one or more third parties and is assigned to a cluster of identification codes used by third parties to identify the product; and
storing, at the storage device of the remote server, the universal product identifier with the updated cluster of identification codes including the normalized identification code and the first matching rule, wherein the first matching rule is stored with a label identifying the third party and the universal product identifier.

2. The method of claim 1, wherein normalizing the identification code further comprises one of:
adding attributes described in the set of guidelines received from the third party that are lacking from the identification code; and
removing attributes from the identification code that are not described in the set of guidelines.

3. The method of claim 1, wherein each matching rule of the set of matching rules is assigned a priority, the method further comprising:
accessing a first priority assigned the first matching rule;
identifying a second matching rule of the set of matching rules that identifies a second cluster of identification codes, wherein the second matching rule is assigned a second priority; and
responsive to determining the first priority assigned to the first matching rule to be higher than second priority assigned to the second matching rule, identifying the first cluster of identification codes as representing the product identified by the normalized identification code.

4. The method of claim 3, wherein the priority assigned to each matching rule of the set of matching rules is determined based on an accuracy of identification codes previously assigned clusters of identification codes by the matching rule.

5. The method of claim 3, further comprising:
updating a record of matching rules in response to identifying the first cluster of identification codes, wherein the updated record indicates that the normalized identification code was mapped to the first cluster of identification codes by the first matching rule and a timestamp when the identification code was received from the third party; and
storing, at the storage device of the remote server, the updated record.

6. The method of claim 1, further comprising:
responsive to receiving the identification code from a third party, accessing, from the storage device of the remote server, the plurality of universal product identifiers and a plurality of identification codes received from a plurality of third parties identifying products provided by the plurality of third parties;
generating one or more clusters of identification codes by applying the set of matching rules to the plurality of identification codes, wherein the set of matching rules group identification codes with attributes identifying a common product of the plurality of products into clusters of identification codes; and
for each universal product identifier, assigning the universal product identifier to a cluster of identification codes of the one or more identification codes.

7. The method of claim 1, further comprising:
determining that the third party belongs to a group of related third parties based on an attribute of the normalized identification code;
comparing the normalized identification code to a plurality of identification codes received from third parties of the group of related third parties to identify a subset of the plurality of identification codes identifying the product identified by the normalized identification code; and
generating a shared product identifier for identification codes in the subset, wherein the set of matching rules is applied to the shared product identifier and the identified cluster of identification codes is mapped to the shared product identifier.

8. The method of claim 1, further comprising:
responsive to determining that the normalized identification code does not map to a cluster of identification codes, generating a scoped product identifier that identifies the product, wherein the scoped product identifier comprises an indicator that the product is specific to the third party.

9. The method of claim 1, further comprising:
responsive to the first matching rule mapping the identification code to the cluster of identification codes, halting the application of the set of matching rules to the normalized identification code.

10. The method of claim 1, further comprising:
receiving, at the remote server, a second identification code for a second product from the third party;
normalizing the second identification code according to the set of guidelines received from the third party; and
identifying a cluster of identification codes that represents the product identified by the second identification code by applying the first matching rule stored at the storage device of the remote server.

11. The method of claim 10, further comprising:
responsive to the first matching rule not identifying a cluster of identification codes that represents the product identified by the second identification code, applying the set of matching rules to the second identification code sequentially until a second matching rule different from the first matching rule identifies a cluster of identification codes that represents the product identified by the second identification code;
updating, at the remote server, a record identifying that the second matching rule mapped the normalized second identification code to the cluster of identification codes and a timestamp when the second identification code was received from the third party; and
storing the second matching rule that mapped the normalized second identification code to the cluster of identification codes, wherein the second matching rule is stored with a label identifying the third party and the universal product identifier.

12. A non-transitory computer-readable storage medium comprising instructions that, when executed by a processor, cause the processor to:
receive, at a remote server, an identification code for a product from a third party, wherein the identification code comprises attributes that the third party uses to identify the product;
normalize the identification code according to a set of guidelines received from the third party, wherein the normalization causes the identification code to resemble previous identification codes received from the third party;
identify, from a plurality of identification codes, a cluster of identification codes that represents the product identified by the normalized identification code by applying a set of matching rules to the normalized identification code, wherein each matching rule of the set of matching rules is applied sequentially until a first matching rule of the set of matching rules maps the normalized identification code to the cluster of identification codes based on an attribute of the normalized identification code;
update the cluster of identification codes assigned to the identified universal product identifier to include the normalized identification code;
identify, from a plurality of universal product identifiers, a universal product identifier that represents the product of the cluster of identification codes, wherein each universal product identifier of the plurality of universal product identifiers represents a product provided by one or more third parties and is assigned to a cluster of identification codes used by third parties to identify the product; and
store, at the storage device of the remote server, the universal product identifier with the updated cluster of identification codes including the normalized identification code and the first matching rule, wherein the first matching rule is stored with a label identifying the third party and the universal product identifier.

13. The non-transitory computer readable storage medium of claim 12, wherein instructions for normalizing the identification code further cause the processor to:
add attributes described in the set of guidelines received from the third party that are lacking from the identification code; and
remove attributes from the identification code that are not described in the set of guidelines.

14. The non-transitory computer readable storage medium of claim 12, wherein each matching rule of the set of matching rules is assigned a priority, the instructions further causing the processor to:
access a first priority assigned the first matching rule;
identify a second matching rule of the set of matching rules that identifies a second cluster of identification codes, wherein the second matching rule is assigned a second priority; and
responsive to determining the first priority assigned to the first matching rule to be higher than second priority assigned to the second matching rule, identify the first cluster of identification codes as representing the product identified by the normalized identification code.

15. The non-transitory computer readable storage medium of claim 14, wherein the priority assigned to each matching rule of the set of matching rules is determined based on an accuracy of identification codes previously assigned clusters of identification codes by the matching rule.

16. The non-transitory computer readable storage medium of claim 14, further comprising instructions that cause the processor to:
update a record of matching rules in response to identifying the first cluster of identification codes, wherein the updated record indicates that the normalized identification code was mapped to the first cluster of identification codes by the first matching rule and a timestamp when the identification code was received from the third party; and
store, at the storage device of the remote server, the updated record.

17. The non-transitory computer readable storage medium of claim 12, further comprising instructions that cause the processor to:
responsive to receiving the identification code from a third party, access, from the storage device of the remote server, the plurality of universal product identifiers and a plurality of identification codes received from a plurality of third parties identifying products provided by the plurality of third parties;
generate one or more clusters of identification codes by applying the set of matching rules to the plurality of identification codes, wherein the set of matching rules group identification codes with attributes identifying a common product of the plurality of products into clusters of identification codes; and
for each universal product identifier, assign the universal product identifier to a cluster of identification codes of the one or more identification codes.

18. The non-transitory computer readable storage medium of claim 12, further comprising instructions that cause the processor to:
determine that the third party belongs to a group of related third parties based on an attribute of the normalized identification code;
compare the normalized identification code to a plurality of identification codes received from third parties of the group of related third parties to identify a subset of the plurality of identification codes identifying the product identified by the normalized identification code; and
generate a shared product identifier for identification codes in the subset, wherein the set of matching rules is applied to the shared product identifier and the identified cluster of identification codes is mapped to the shared product identifier.

19. The non-transitory computer readable storage medium of claim 12, further comprising instructions that cause the processor to:
responsive to determining that the normalized identification code does not map to a cluster of identification codes, generate a scoped product identifier that identifies the product, wherein the scoped product identifier comprises an indicator that the product is specific to the third party.

20. The non-transitory computer readable storage medium of claim 12, further comprising instructions that cause the processor to:
responsive to the first matching rule mapping the identification code to the cluster of identification codes, halting the application of the set of matching rules to the normalized identification code.

21. The non-transitory computer readable storage medium of claim 12, further comprising instructions that cause the processor to:
receive, at the remote server, a second identification code for a second product from the third party;
normalize the second identification code according to the set of guidelines received from the third party; and
identify a cluster of identification codes that represents the product identified by the second identification code by applying the first matching rule stored at the storage device of the remote server.

22. The non-transitory computer readable storage medium of claim 21, further comprising instructions that cause the processor to:
responsive to the first matching rule not identifying a cluster of identification codes that represents the product identified by the second identification code, apply the set of matching rules to the second identification code sequentially until a second matching rule different from the first matching rule identifies a cluster of identification codes that represents the product identified by the second identification code;
update, at the remote server, a record identifying that the second matching rule mapped the normalized second identification code to the cluster of identification codes and a timestamp when the second identification code was received from the third party; and
store the second matching rule that mapped the normalized second identification code to the cluster of identification codes, wherein the second matching rule is stored with a label identifying the third party and the universal product identifier.
